(19) United States
(12) Patent Application Publication
(10) Pub. No.: US 2025/0217541 A1
(43) Pub. Date: Jul. 3, 2025

(54) OPTIMIZATION METHOD AND SYSTEM BASED ON LOW-RANK REGRESSION OF HISTORICAL ITERATION DATA

(71) Applicant: Wuhan Yuwei Optical Software Co., Ltd., Hubei (CN)

(72) Inventors: Haiqing Wei, Hubei (CN); Xianhua Ke, Hubei (CN)

(73) Assignee: Wuhan Yuwei Optical Software Co., Ltd., Hubei (CN)

(21) Appl. No.: 18/616,196

(22) Filed: Mar. 26, 2024

(30) Foreign Application Priority Data
Dec. 31, 2023 (CN) 202311868627.4

(51) Int. Cl. G06F 30/20; G06F 111/10

(52) U.S. Cl. CPC G06F 30/20; G06F 2111/10

(57) ABSTRACT

An optimization method and system based on low-rank regression of historical iteration data are provided. The method includes: obtaining historical iteration data including change data of physical parameters to be optimized and result deviation data obtained through simulation by using a forward model; and iteratively updating matrix coefficients and the physical parameters to be optimized continuously through low-rank linear regression based on the change data of the physical parameters to be optimized and the result deviation data, and evaluating updated physical parameters to be optimized, until an iteration stop condition is met. A low-rank matrix approximation that represents a small signal linear relationship between the change data of the physical parameters and the result deviation data in the historical iteration is construct and used to solve the optimization problem, which effectively reduces the computational complexity of the optimization process and improves the computational efficiency of the optimization process.

### CROSS-REFERENCE TO RELATED APPLICATION

This application claims the priority benefit of China application serial no. 202311868627.4, filed on Dec. 31, 2023. The entirety of the above-mentioned patent application is hereby incorporated by reference herein and made a part of this specification.

### BACKGROUND

### Technical Field

The disclosure belongs to the field of computer technology, and more specifically, relates to an optimization method and system based on low-rank regression of historical iteration data.

### Description of Related Art

In various fields such as intelligent manufacturing, digital twins, optoelectronic technology, and industrial engineering, optimization problems of specific physical parameters frequently arise. For instance, in computational lithography, regarding a key technology for smart manufacturing, the optical proximity correction (OPC) achieves resolution enhancement through optimized mask design, thus promoting the advancement of technology nodes. During this process, mask optimization efficiency is highly demanding. In addition, in complex optimization problems such as fluid simulation calculations and digital twin model calibration of intelligent manufacturing equipment or production lines, the requirements for computational efficiency are also growing.

The mainstream optimization methods in the related art are optimization methods for physical parameters in industrial production and manufacturing, including a variety of global optimization methods and local optimization methods. In these mainstream optimization methods, it is required to repeatedly solve the physical parameters to be optimized based on the output deviation of the forward model during the optimization process. For complex processes such as the abovementioned mask optimization in computational lithography and solution of fluid simulation diffusion equations, the calculation process of the forward model is relatively complex, and the step-by-step reverse solution process is cumbersome and time-consuming. Each iteration of the optimization process requires a call to the forward model. According to the deviation of its output, the forward model is reversely solved gradually to calculate the updated values of the physical parameters to be optimized. The computational consumption of this reverse solution process takes up most of the time in the optimization process. Therefore, how to improve the computational efficiency of the optimization process is a technical issue that needs to be solved urgently in the industry.

### SUMMARY

In view of the defects found in the related art, the disclosure aims to improve the calculation efficiency of the optimization process and to solve the problem of low efficiency of the optimization methods in the related art.

To achieve the above, in the first aspect, the disclosure provides an optimization method based on low-rank regression of historical iteration data, and the method includes the following steps.

Historical iteration data is obtained, and the historical iteration data includes change data of physical parameters to be optimized and result deviation data obtained through simulation by using a forward model.

Based on the change data of the physical parameters to be optimized and the result deviation data, matrix coefficients and the physical parameters to be optimized are iteratively updated continuously through low-rank linear regression, and updated physical parameters to be optimized are evaluated until an iteration stop condition is met.

The matrix coefficients are used to characterize a linear relationship between the change data of the physical parameters to be optimized and the result deviation data, and updated values of the physical parameters to be optimized are determined based on the matrix coefficients of a current round of iteration and simulation result deviation values of a previous round of iteration.

Optionally, the iteratively updating the matrix coefficients and the physical parameters to be optimized continuously through the low-rank linear regression and evaluating the updated physical parameters to be optimized includes the following.

Based on the change data of the physical parameters to be optimized and the result deviation data, estimation is performed through low-rank linear regression, and the matrix coefficients are updated.

Based on updated matrix coefficients and the simulation result deviation values of the previous iteration, the physical parameters to be optimized are updated.

Based on the updated physical parameters to be optimized, simulation is performed through a forward model, and simulation result deviation values of the current round of iteration are determined.

Based on the current number of iterations and the simulation result deviation values of the current round of iteration, it is determined to execute a next round of iteration or to stop the iteration.

Optionally, the performing the estimation through the low-rank linear regression and updating the matrix coefficients based on the change data of the physical parameters to be optimized and the result deviation data specifically includes updating the matrix coefficients through the following formula:

$$\tilde{A} = {\sum }_{i = k - r}^{k - 1} {λ}_{i} \vert {y}_{i} {x}_{i} \vert ,$$

where Ã represents an estimated value of the matrix coefficients, |yᵢ [symbol] xᵢ| uses a Dirac symbol, |.>represents a right vector, <.| represents a left vector, λ is a weight, i represents the iteration number, xᵢ represents the change values of the physical parameters to be optimized in an i^{th} iteration, yᵢ represents the result deviation values of the i^{th} iteration, k represents the number corresponding to a current iteration, r represents the number of iterations corresponding to the historical iteration data, r is less than k, and r and k increase as the number of iterations increases.

Optionally, singular value decomposition can be applied to calculate the estimated value

Ā:Ā=Σᵢ₌₁^{r′}λᵢ|y′ᵢ [symbol] x′ᵢ|,

where all x′ vectors are orthogonal to one another and r′≤r.

Optionally, before the physical parameters to be optimized are updated based on the updated matrix coefficients and the simulation result deviation values of the previous iteration, the method further includes the following. A Hermitian conjugate of the matrix coefficients is determined through the following formula:

$${\tilde{A}}^{+} = {\sum }_{i = k - r}^{k - 1} {λ}_{i}^{*} \vert {x}_{i} {y}_{i} \vert ,$$

where Ã⁺ represents an estimated value of the Hermitian conjugate of the matrix coefficients, and Δᵢ* represents a complex conjugate of λᵢ.

Optionally, the updating the physical parameters to be optimized includes the following. An optimization algorithm is selected, and reference value directions and reference values of the change of the parameters to be optimized for this iteration are calculated. It is worth noting that in the disclosure, the optimization algorithm is not limited, and methods such as the least squares method, the conjugate gradient method, regularization, or convex optimization can be used for solution.

Optionally, selection of the optimization algorithm includes the use of the least squares method

$$x = arg {min}_{x} {‖ \tilde{A} x - y ‖}_{2}^{2} ,$$

and the estimated value of the matrix coefficients and the estimated value of its Hermitian conjugate are brought into x⁺A⁺Ax to calculate the required items.

Optionally, the performing the simulation through the forward model and determining the simulation result deviation value of the current round of iteration based on the updated physical parameters to be optimized includes the following.

The updated physical parameters to be optimized are treated as a set of simulation condition, simulation is performed through the forward model, and a simulation result value is obtained.

Based on reference target values and the simulation result values, the simulation result deviation values of the current round of iteration are determined through difference analysis.

Optionally, the determining to execute the next round of iteration or to stop the iteration based on the current number of iterations and the simulation result deviation values of the current round of iteration includes the following.

If it is determined that the current number of iterations reaches the maximum number of iterations or the simulation result deviation values are less than predetermined deviation values, it is determined to stop the iteration, otherwise, it is determined to execute the next round of iteration. Optionally, before execution of the next round of iteration, the method further includes

the following.

Based on the change values of the physical parameters to be optimized and the simulation result deviation values in the current round of iteration, the historical iteration data is updated.

In the second aspect, the disclosure further provides an optimization system based on low-rank regression of historical iteration data, and the system includes a historical data acquisition module and an iteration module.

The historical data acquisition module is used to obtain historical iteration data including change data of physical parameters to be optimized and result deviation data obtained through simulation by using a forward model.

The iteration module is used to iteratively update the matrix coefficients and the physical parameters to be optimized continuously through low-rank linear regression based on the change data of the physical parameters to be optimized and the result deviation data and evaluate the updated physical parameters to be optimized until an iteration stop condition is met.

The matrix coefficients are used to characterize a linear relationship between the change data of the physical parameters to be optimized and the result deviation data, and updated values of the physical parameters to be optimized are determined based on the matrix coefficients of a current round of iteration and simulation result deviation values of a previous round of iteration.

In the third aspect, the disclosure further provides an electronic apparatus including at least one memory for storing a program and at least one processor used to execute the program stored in the at least one memory. When the program stored in the memory is executed, the processor is used to execute the method described in the first aspect or in any possible implementation manner of the first aspect.

In the fourth aspect, the disclosure further provides a computer-readable storage medium, and the computer-readable storage medium stores a computer program. When a computer program runs on a processor, the processor is enabled to execute the method described in the first aspect or in any possible implementation manner of the first aspect.

It can be understood that the beneficial effects of the above second aspect to fourth aspect can be referred to the relevant description in the above first aspect, so description thereof is not repeated herein.

To sum up, the above technical solutions provided by the disclosure have the following beneficial effects compared with the related art.

In the second half of the iterations, through the use of the change data of the physical parameters to be optimized in historical iteration and the result deviation data obtained through forward model calculation, a low-rank matrix approximation that represents the small signal linear relationship between the two is constructed (small signal means that the change data of the physical parameters to be optimized are small values, and the result deviation data is also a small value). A quick regression estimate is performed on the matrix coefficients, and the updated physical parameters to be optimized are obtained accordingly. There is no need to perform a stepwise inverse solution of the forward model, and the constructed linear relationship is used to replace the inverse solution of the complex forward model. In this way, the computational complexity of the optimization process may be effectively lowered, and the computational efficiency of the optimization solution may be improved. Further, linear approximation is used for local solution, and analytical methods may be used to quickly solve the problem. It is not easy to fall into oscillation and has faster convergence speed.

### BRIEF DESCRIPTION OF THE DRAWINGS

To make the technical solutions provided in the disclosure or the related art more clearly illustrated, several accompanying drawings required by the embodiments or the related art for description are briefly introduced as follows. Obviously, the drawings in the following description are some embodiments of the disclosure, and for a person having ordinary skill in the art, other drawings can be obtained based on these drawings without any inventive effort.

FIG. 1 is a first schematic flow chart of an optimization method based on low-rank regression of historical iteration data provided by the disclosure.

FIG. 2 is a second schematic flow chart of the optimization method based on the low-rank regression of the historical iteration data provided by the disclosure.

FIG. 3 is a third schematic flow chart of the optimization method based on the low-rank regression of the historical iteration data provided by the disclosure.

FIG. 4 is a schematic structural diagram of an optimization system based on low-rank regression of historical iteration data provided by the disclosure.

### DESCRIPTION OF THE EMBODIMENTS

In order to make the objectives, technical solutions, and advantages of the disclosure clearer and more comprehensible, the disclosure is further described in detail with reference to the drawings and embodiments. It should be understood that the specific embodiments described herein serve to explain the disclosure merely and are not used to limit the disclosure.

In the embodiments of the disclosure, words such as “exemplary” or “for example” are used to represent examples, illustrations, or explanations. Any embodiment or design described in the embodiments of the disclosure as “exemplary” or “for example is not intended to be construed as preferred or advantageous over other embodiments or designs. Rather, the use of the words “exemplary” or “for example” is intended to present the concept in a concrete manner.

In the embodiments of the disclosure, unless otherwise specified, “plurality” means two or more than two. For example, a plurality of processing units refer to two or more processing units, etc. A plurality of components refer to two or more components, etc.

Next, the technical solutions provided in the embodiments of the disclosure are introduced.

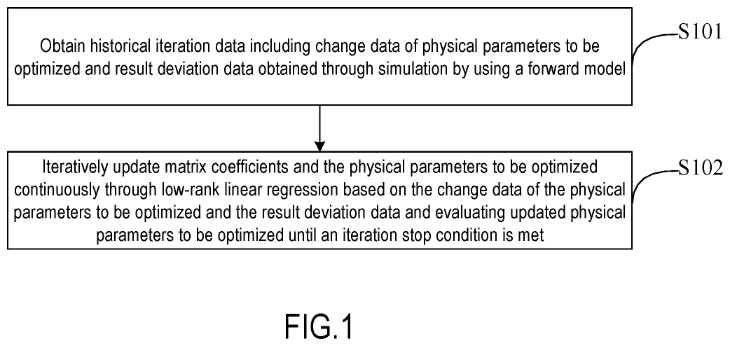

FIG. 1 is a first schematic flow chart of an optimization method based on low-rank regression of historical iteration data provided by the disclosure. As shown in FIG. 1, the execution subject of this method may be an electronic device, such as a server. The method includes step S101 and step S102.

In step S101, historical iteration data is obtained, and the historical iteration data includes change data of physical parameters to be optimized and result deviation data obtained through simulation by using a forward model.

Specifically, optimization methods in the related art may be used to obtain and store historical iteration data of several iterations. The historical iteration data includes a change value x of the physical parameters to be optimized and deviation y outputted by the forward model in each iteration, and x and y respectively constitutes a change data set X of the physical parameters to be optimized (i.e., change data of the physical parameters to be optimized) and a result deviation data set Y (i.e., result deviation data).

The physical parameters to be optimized may be logical signals, such as force signals, position signals, velocity signals, acceleration signals, light signal, a graphic image signal, or an electrical signal, etc.

The physical parameters to be optimized may be digital signals, such as time discrete acquisition signals or spatial discrete acquisition signals.

In step S102, based on the change data of the physical parameters to be optimized and the result deviation data, matrix coefficients and the physical parameters to be optimized are iteratively updated continuously through low-rank linear regression, and updated physical parameters to be optimized are evaluated until an iteration stop condition is met.

The matrix coefficients are used to characterize a linear relationship between the change data of the physical parameters to be optimized and the result deviation data, and an updated value of the physical parameters to be optimized is determined based on the matrix coefficients of a current round of iteration and simulation result deviation values of a previous round of iteration.

It can be understood that in an optimization and solution process for the physical parameters to be optimized, especially when an optimization algorithm has found a neighborhood near the optimal solution, where an objective function to be optimized may be approximately represented as a multi-variable quadratic function. Continuous use of global optimization or other nonlinear optimization algorithms can easily cause the iterative process to fall into oscillation and converge very slowly.

The optimization and solution process for the physical parameters to be optimized may be divided into a first half of iterations and a second half of iterations. The first half of the iterations may use optimization methods in related art (various global optimization methods and local optimization methods) and accumulate historical iteration data for use by this method. In the second half of the iterations, in each iteration, the matrix coefficients and physical parameters to be optimized may be iteratively updated through low-rank linear regression, and the updated physical parameters to be optimized may be evaluated. An evaluation result may indicate that the iteration stop condition is met or indicate that the iteration stop condition is not met. Using the change value x of the physical parameters to be optimized in each iteration in the historical iteration and the result deviation value y obtained through forward model calculation, a low-rank matrix approximation is constructed that represents a small signal linear relationship Ax=y between the two. The matrix coefficients A is quickly estimated through low-rank regression to update the estimated values of the matrix coefficients A at each iteration.

Write x and y in vector form, x∈Rⁿ and y∈^{m}, and the matrix coefficient A∈R^{m×n}. The estimated value of the matrix coefficient A may be calculated by selecting a total of r iterations of historical data based on the rank r to calculate the estimated value of A.

Optionally, in order to ensure the applicability of the linear relationship, when selecting the historical iteration data, the first few iterations shall be eliminated to avoid the inapplicability of local linear approximation caused by the larger step sizes in the first few iterations.

Optionally, as the number of iterations increases, the selected rank r also increases.

According to the updated matrix coefficient A, updated reference data of the physical parameters to be optimized is obtained to update the physical parameters to be optimized. There is no need to perform a stepwise inverse solution of the forward model, and the constructed linear relationship is used to replace the inverse solution of the complex forward model. In this way, the computational complexity of the optimization process may be effectively lowered, and the computational efficiency of the optimization solution may be improved. Further, linear approximation is used for local solution, and analytical methods may be used to quickly solve the problem. It is not easy to fall into oscillation and has faster convergence speed.

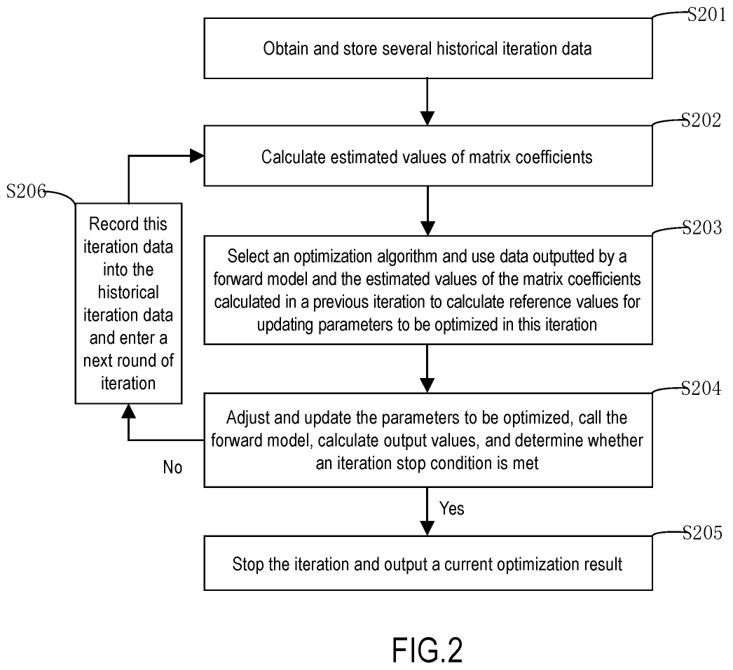

FIG. 2 is a second schematic flow chart of the optimization method based on the low-rank regression of the historical iteration data provided by the disclosure. As shown in FIG. 2, the method includes the following step S201, step S202, step S203, step S204, step S205, and step S206.

In step S201, several historical iteration data are obtained and stored.

Optimization methods in the related art may be used to obtain and store historical data of several iterations. The historical data is the change value x of the physical parameters to be optimized and the deviation y outputted by the forward model in each iteration, and x and y respectively constitute the change data set X of the physical parameters to be optimized and the result deviation data set Y.

In step S202, estimated values of the matrix coefficients are calculated. That is, based on the change data of the physical parameters to be optimized and the result deviation data, it is estimated through low-rank linear regression, and the matrix coefficients are updated.

The estimated value

Ã=Σᵢ₌₁^{r}λᵢ|yᵢ [symbol] xᵢ|

of the matrix coefficients may be calculated using the iteration history data obtained in step S201. This estimated value may be used to update the matrix coefficients.

Herein, Ã represents the estimated value of the matrix coefficients, |yᵢ [symbol] xᵢ| uses a Dirac symbol, |.>represents a right vector, <.| represents a left vector, λ is a weight, i represents the iteration number, xᵢ represents the change value of the physical parameters to be optimized in an i^{th} iteration, yᵢ represents a result deviation value of the i^{th} iteration, and r represents the number of iterations corresponding to the historical iteration data.

Singular value decomposition may be applied to calculate the estimated value of the matrix coefficient Ã, and the estimated value is then used to update the matrix coefficients A.

Optionally, when it is necessary to calculate a Hermitian conjugate of the matrix coefficients, an estimated value

Ã⁺=Σᵢ₌₁^{r}λᵢ*|xᵢ [symbol] yᵢ|

is calculated, where Ã⁺represents an estimated value of the Hermitian conjugate of the matrix coefficient, and λᵢ* represents a complex conjugate of λᵢ.

It can be understood that in the process of updating the physical parameters to be optimized based on the updated matrix coefficients and the simulation result deviation values of the previous round of iteration, optimization algorithms may be used, such as the least squares method, the conjugate gradient method, regularization, convex optimization, and other algorithms. If it is necessary to calculate the Hermitian conjugate of the matrix coefficient when calling these optimization algorithms, the method for fast regression estimation of the matrix coefficient provided by the disclosure may also be used to quickly estimate the Hermitian conjugate of the matrix coefficient. The estimated value Ã⁺ of the Hermitian conjugate of the matrix coefficient may be approximated as the Hermitian conjugate of the matrix coefficient.

In step S203, an optimization algorithm is selected, and the data outputted by the forward model and estimated value of the matrix coefficients calculated in the previous iteration are used to calculate reference values for updating the parameters to be optimized in this iteration.

An optimization algorithm is selected, and based on the estimated values of the matrix coefficients obtained in step S202 and output deviation values calculated through the forward model after the previous iteration, a reference value direction and a reference value x of the change of the physical parameters to be optimized for this iteration are calculated. It is worth noting that in the disclosure, the optimization algorithm is not limited, and methods such as the least squares method, the conjugate gradient method, regularization, or convex optimization may be used for solution.

Optionally, the least squares method may be used:

$$x = arg {min}_{x} {‖ \tilde{A} x - y ‖}_{2}^{2} ,$$

and the estimated values of the matrix coefficients calculated in step S202 and the estimated values of its Hermitian conjugate are brought into x⁺A⁺Ax to calculate the required items.

In step S204, the parameters to be optimized are adjusted and updated, the forward model is called, output values are calculated, and it is determined whether the iteration stop condition is met.

According to the change reference direction and the reference values of the physical parameters to be optimized obtained in step S203, the physical parameters to be optimized are adjusted and updated (that is, based on the updated matrix coefficients and the simulation result deviation values of the previous round of iteration, the physical parameters to be optimized are updated, the change reference direction and the reference values of the physical parameters to be optimized are determined, and the physical parameters to be optimized are adjusted and updated accordingly), and the updated physical parameters to be optimized are obtained (the updated physical parameters to be optimized are treated as a simulation condition). The forward model is called to perform simulation, and the output values (i.e., the simulation result values) are calculated. Further, the output values of the forward model are compared with the reference target values (for example, calculating the difference) to obtain the output deviation values (i.e., the simulation result deviation values), and it is determined whether the iteration stop condition is met. If the stop condition is met, step S205 is the performed; if not, step S206 is performed instead. The iteration stop condition may be but not limited to: the number of iterations reaches the maximum iteration limit, or the model output deviation values are less than specified values or predetermined deviation values, etc.

In step S205, the iteration is stopped, and a current optimization result is outputted.

Stopping the iteration and outputting the current optimization result (the updated values of the physical parameters to be optimized obtained in the last iteration) act as a final optimization result.

In step S206, the data of this iteration (the change value of the physical parameters to be optimized and the simulation result deviation values of this iteration) are recorded into the historical iteration data, and the next round of iteration is entered.

Current iteration data, that is, the change values of the physical parameters to be optimized (the change values of the physical parameter to be optimized in the current iteration may be determined based on the change reference direction and the reference values of the physical parameters to be optimized obtained in step S203) as well as the deviation values outputted by the forward model in the current iteration, are recorded into the historical iteration data, and the next round of iteration is entered.

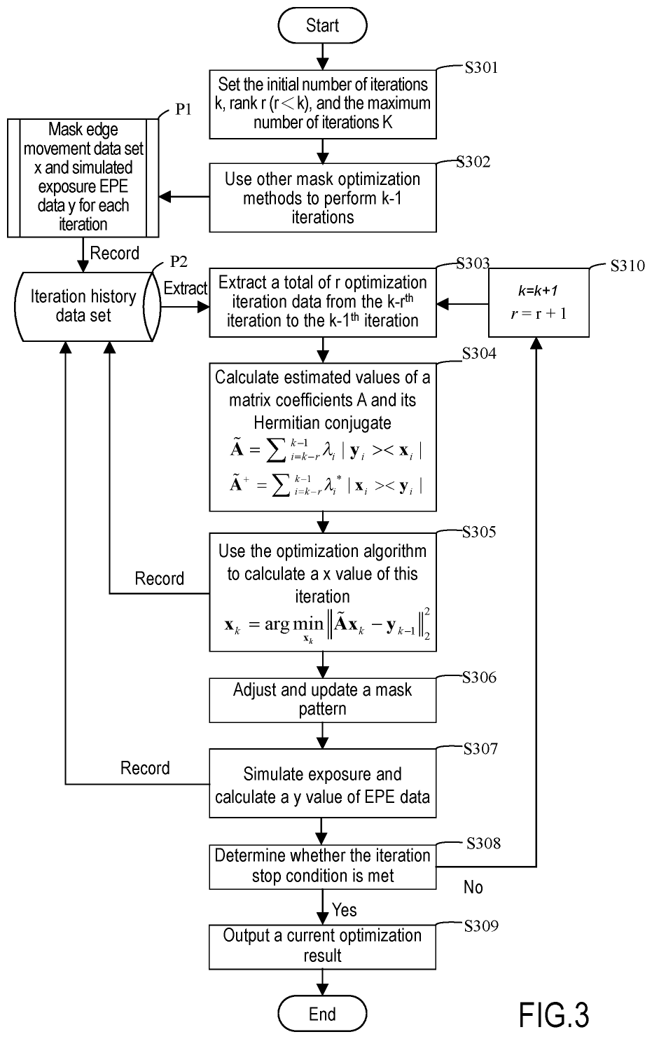

Taking the mask optimization in computational lithography as an example, the optimization method provided by the disclosure is illustrated in the following paragraphs. FIG. 3 is a third schematic flow chart of the optimization method based on the low-rank regression of the historical iteration data provided by the disclosure. The optimization method based on the low-rank regression of the historical iteration data provided by the disclosure is applied to the mask optimization in computational lithography. The specific implementation steps are shown in FIG. 3, and the following steps are included.

In step S301, the initial number of iterations k, rank r, and the maximum number of iterations K are set, all of which are positive integers and satisfy r<k≤K. That is, in the mask optimization process, the method provided by the disclosure is adopted starting from a k^{th} iteration, and the historical iteration data used is the data of a total of r iterations from a k−r^{th} to a k−1th iteration.

In step S302, other mask optimization methods (in the related art) are used to perform k−1 iterations, and each iteration data shown in P1 is stored in an iteration history data set P2. The iteration history data set, includes a mask edge movement data set X and an edge placement error (EPE) data set Y, for each iteration. The mask edge movement data set X consists of movement directions and steps of each edge, and the edge placement error (EPE) data set Y consists of the EPE data obtained by exposure simulation of each mask after movement of corresponding X.

It is worth noting that for EPE, the data set Y may be but not limited to a critical dimension error (CD error) set, an EPE set of each edge segment, or a photoresist contour error set, etc.

In step S303, a total of r optimization iteration data from the k−r^{th} iteration to the k−1^{th} iteration are extracted from the historical data set P2.

In step S304, the r groups of historical iteration data obtained in step S303 are used to calculate the estimated value of the matrix coefficients A:

Ã=Σᵢ₌ₖ₋ᵣ^{k-1}λᵢ|yᵢ [symbol] xᵢ|

and the estimated value of its Hermitian conjugate A⁺:

Ã⁺=Σᵢ₌ₖ₋ᵣ^{k-r}λᵢ* [symbol] yᵢ|

where i represents the i^{th} iteration.

k represents the number corresponding to the current iteration, r represents the number of iterations corresponding to the historical iteration data, r is less than k, and r and k increase as the number of iterations increases. For instance, after the current round of iteration ends and before entering the next round of iteration, the number of iterations k=k+1 and the rank r=r+1 are set.

In step S305, the least squares method is used to calculate the xx value of this iteration using the yₖ₋₁ value calculated in the previous iteration and the matrix coefficient estimated value Ã obtained in step S304:

$${x}_{k} = arg {min}_{{x}_{k}} {‖ \tilde{A} {x}_{k} - {y}_{k - 1} ‖}_{2}^{2} ,$$

and store it in the iteration history data set P2, where ∥.∥2 represents the 2-norm. It is worth noting that in the disclosure, the optimization and solution algorithm is not limited, and methods such as the least squares method, the conjugate gradient method, regularization, or convex optimization may be used for solution.

In step S306, the mask is adjusted and updated according to the mask edge movement data obtained in step S305.

In step S307, the mask of step S306 is used, and the forward model is called to simulate the exposure. The EPE value yₖ corresponding to xx of this iteration is calculated and stored in the iteration history data set P2.

In step S308, the iteration stop condition is determined, which is, whether an iterator of the current optimization process reaches the maximum number of iterations, that is, k>K, or whether the EPE obtained in step S307 satisfies the iteration stop condition |EPE|<ε. The iteration stop determination conditions are not limited to the above two situations. If the determination result is “Yes”, step S309 is performed, and if the determination result is “No”, step S310 is performed instead.

In step S309, the iteration is stopped, and a current result is outputted as a mask optimization result.

In step S310, the number of iterations is set k=k+1, the rank r=r+1, and a new round of iteration is entered.

An optimization system based on low-rank regression of historical iteration data provided by the disclosure is described in the following paragraphs. The optimization system based on the low-rank regression of the historical iteration data described in the following paragraphs and the optimization method based on the low-rank regression of the historical iteration data described in the foregoing embodiments may correspond to each other.

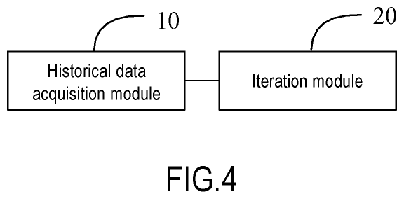

FIG. 4 is a schematic structural diagram of an optimization system based on low-rank regression of historical iteration data provided by the disclosure. As shown in FIG. 4, the system includes a historical data acquisition module 10 and an iteration module 20.

The historical data acquisition module 10 is used to obtain historical iteration data, including change data of physical parameters to be optimized and result deviation data obtained through simulation by using a forward model.

The iteration module 20 is used to iteratively update the matrix coefficients and the physical parameters to be optimized continuously through the low-rank linear regression, based on the change data of the physical parameters to be optimized and the result deviation data, and evaluate updated physical parameters to be optimized until an iteration stop condition is met.

The matrix coefficients are used to characterize a linear relationship between the change data of the physical parameters to be optimized and the result deviation data, and updated values of the physical parameters to be optimized are determined based on the matrix coefficients of a current round of iteration and simulation result deviation values of a previous round of iteration.

It should be understood that the abovementioned device is used to perform the method in the abovementioned embodiments. The implementation principles and technical effects of the corresponding program modules in the device are similar to those described in the above method. The working process of the device can be referred to the corresponding process in the above method, and description is not going to be provided again herein.

Based on the method in the foregoing embodiments, an embodiment of the disclosure provides an electronic apparatus. The apparatus may include at least one memory for storing a program and at least one processor for executing the program stored in the memory. Herein, when the program stored in the memory is executed, the processor is used to execute the method described in the above embodiments.

Based on the method in the above embodiments, an embodiment of the disclosure provides a computer-readable storage medium, and the computer-readable storage medium stores a computer program. When the computer program is running on the processor, the processor is enabled to execute the method in the above embodiments.

Based on the method in the above embodiments, an embodiment of the disclosure provides a computer program product. When the computer program product is running on the processor, the processor is enabled to execute the method in the above embodiments.

It can be understood that the processor in the embodiments of the disclosure may be a central processing unit (CPU), may be a general-purpose processor, a digital signal processor (DSP), an application specific integrated circuit (ASIC), or a field programmable gate array (FPGA), or may be a programmable logic device, a transistor logic device, a hardware component, or any combination thereof. The general-purpose processor may be a microprocessor or may also be any conventional processor.

The method steps in the embodiments of the disclosure may be implemented by hardware or by a processor executing software instructions. The software instructions may be formed by a corresponding software module, and the software module may be stored in a random access memory (RAM), a flash memory, a read-only memory (ROM), a programmable rom (PROM), an erasable PROM (EPROM), an electrically EPROM (EEPROM), a register, a hard disk, a mobile hard disk, a CD-ROM, or any other form of storage media well known in the art. An exemplary storage medium is coupled to the processor, such that the processor can read information from the storage medium and write information to the storage medium. Certainly, the storage medium may also be an integral part of the processor. The processor and storage medium may be located in an ASIC.

All or part of the foregoing embodiments may be implemented by software, hardware, firmware, or any combination thereof. When implementation is performed by using software, it may be implemented in whole or in part in the form of a computer program product. The computer program product includes one or a plurality of computer instructions. When the computer program instructions are loaded and executed on the computer, the processes or functions according to the embodiments of the disclosure will be generated in whole or in part.

The computer can be a general purpose computer, a special purpose computer, a computer network, or other programmable apparatuses. The computer instructions may be stored in or transmitted through a computer-readable storage medium. For instance, the computer instruction may be transmitted from one website, computer, server, or data center to another website, computer, server, or data center by wired (e.g., coaxial cable, optical fiber, digital subscriber line (DSL)) or wireless (e.g., infrared, wireless, microwave, etc.) means. The computer-readable storage medium may be any available medium that may be accessed by a computer or a data storage device such as a server or a data center integrated with one or more available media. The available medium may be a magnetic medium (e.g., a floppy disk, a hard disk, or a magnetic tape), an optical medium (e.g., DVD), or a semiconductor medium (e.g., a solid state disk (SSD)), etc.

It can be understood that the various numerical numbers involved in the embodiments of the disclosure are only for convenience of description and are not used to limit the scope of the embodiments of the disclosure.

A person having ordinary skill in the art should be able to easily understand that the above description is only preferred embodiments of the disclosure and is not intended to limit the disclosure. Any modifications, equivalent replacements, and modifications made without departing from the spirit and principles of the disclosure should fall within the protection scope of the disclosure.

What is claimed is:

1. An optimization method based on low-rank regression of historical iteration data, comprising:
obtaining historical iteration data comprising change data of physical parameters to be optimized and result deviation data obtained through simulation by using a forward model; and
iteratively updating matrix coefficients and the physical parameters to be optimized continuously through low-rank linear regression based on the change data of the physical parameters to be optimized and the result deviation data, and evaluating updated physical parameters to be optimized until an iteration stop condition is met,
wherein the matrix coefficients are used to characterize a linear relationship between the change data of the physical parameters to be optimized and the result deviation data, and updated values of the physical parameters to be optimized are determined based on the matrix coefficients of a current round of iteration and simulation result deviation values of a previous round of iteration.

2. The optimization method based on the low-rank regression of the historical iteration data according to claim 1, wherein the iteratively updating the matrix coefficients and the physical parameters to be optimized continuously through the low-rank linear regression, and evaluating the updated physical parameters to be optimized comprises:
performing estimation through low-rank linear regression and updating the matrix coefficients based on the change data of the physical parameters to be optimized and the result deviation data;
updating the physical parameters to be optimized based on updated matrix coefficients and the simulation result deviation values of the previous iteration;
performing simulation through a forward model and determining simulation result deviation values of the current round of iteration based on the updated physical parameters to be optimized; and
determining to execute a next round of iteration or to stop the iteration based on the current number of iterations and the simulation result deviation values of the current round of iteration.

3. The optimization method based on the low-rank regression of the historical iteration data according to claim 2, wherein the performing the estimation through the low-rank linear regression and updating the matrix coefficients based on the change data of the physical parameters to be optimized and the result deviation data specifically comprises updating the matrix coefficients through the following formula:
$$\tilde{A} = {\sum }_{i = k - r}^{k - 1} {λ}_{i} \vert {y}_{i} {x}_{i} \vert ,$$
wherein Ā represents an estimated value of the matrix coefficients,

|yᵢ [symbol] xᵢ|

uses a Dirac symbol, |.>represents a right vector, <.| represents a left vector, λ is a weight, i represents the iteration number, xᵢ represents the change values of the physical parameters to be optimized in an i^{th} iteration, yᵢ represents result deviation values of the i^{th} iteration, k represents the number corresponding to a current iteration, r represents the number of iterations corresponding to the historical iteration data, r is less than k, and r and k increase as the number of iterations increases.

4. The optimization method based on the low-rank regression of the historical iteration data according to claim 3, wherein before the updating the physical parameters to be optimized based on updated matrix coefficients and the simulation result deviation values of the previous iteration, the optimization method further comprises: determining a Hermitian conjugate of the matrix coefficients through the following formula:
$${\tilde{A}}^{+} = {\sum }_{i = k - r}^{k - 1} {λ}_{i}^{*} \vert {x}_{i} {y}_{i} \vert ,$$
wherein Ā⁺ represents an estimated value of the Hermitian conjugate of the matrix coefficients, and λᵢ* represents a complex conjugate of λᵢ.

5. The optimization method based on the low-rank regression of the historical iteration data according to claim 2, wherein the performing the simulation through the forward model and determining the simulation result deviation values of the current round of iteration based on the updated physical parameters to be optimized comprises:
treating the updated physical parameters to be optimized as a simulation condition, performing simulation through the forward model, and obtaining simulation result values; and
determining the simulation result deviation values of the current round of iteration through difference analysis based on reference target values and the simulation result values.

6. The optimization method based on the low-rank regression of the historical iteration data according to claim 2, wherein the determining to execute the next round of iteration or to stop the iteration based on the current number of iterations and the simulation result deviation values of the current round of iteration comprises:
determining to stop the iteration if it is determined that the current number of iterations reaches the maximum number of iterations or the simulation result deviation values are less than predetermined deviation values, otherwise, determining to execute the next round of iteration.

7. The optimization method based on the low-rank regression of the historical iteration data according to claim 6, before execution of the next round of iteration, further comprising:
updating the historical iteration data based on the change values of the physical parameters to be optimized and the simulation result deviation values in the current round of iteration.

8. An optimization system based on low-rank regression of historical iteration data, comprising:
a historical data acquisition module used to obtain historical iteration data comprising change data of physical parameters to be optimized and result deviation data obtained through simulation by using a forward model; and
an iteration module used to iteratively update matrix coefficients and the physical parameters to be optimized continuously through low-rank linear regression based on the change data of the physical parameters to be optimized and the result deviation data, and evaluate updated physical parameters to be optimized, until an iteration stop condition is met,
wherein the matrix coefficients are used to characterize a linear relationship between the change data of the physical parameters to be optimized and the result deviation data, and updated value of the physical parameters to be optimized are determined based on the matrix coefficients of a current round of iteration and simulation result deviation values of a previous round of iteration.

9. An electronic apparatus, comprising:
at least one memory used to store a program; and
at least one processor used to execute the program stored by the memory and execute the method according to claim 1 when the program stored by the memory is executed.

10. A non-transitory computer-readable storage medium used to store a computer program, wherein when the computer program is run on a processor, the processor is enabled to perform the method according to claim 1.
